(19) United States
(12) Patent Application Publication
(10) Pub. No.: US 2011/0124347 A1
(43) Pub. Date: May 26, 2011

(54) Method And Apparatus for UE Positioning in LTE Networks

(76) Inventors: Byron Hua Chen, Whippany, NJ (US); Jung Ah Lee, Pittstown, NJ (US); William Michael MacDonald, Lebanon, NJ (US)

(21) Appl. No.: 12/883,177

(22) Filed: Sep. 15, 2010

Related U.S. Application Data
(60) Provisional application No. 61/276,669, filed on Sep. 15, 2009.

(51) Int. Cl. H04W 4/02

(52) U.S. Cl. 455/456.1

(57) ABSTRACT

Methods and apparatuses are provided for user equipment positioning in networks. An example method includes computing a location of a user equipment (UE). The computing includes joint scheduling of UL subframes and receiving a Up Link Positioning Reference Signal (UL-PRS). The computing is performed by a network equipment that serves at least one cell site. The UL-PRS is received in a known subframe. The computing may also include estimating an arrival time the UL-PRS from the UE for a plurality of cell sites. In another embodiment, the computing includes determining a one-way delay between

### PRIORITY CLAIM

This application claims the benefit of U.S. Provisional Application No. 61/276,669, filed Sep. 15, 2009.

### FIELD OF THE INVENTION

The invention relates to Location Based Service (LBS) in Long Term Evolution (LTE) Networks.

### BACKGROUND INFORMATION

There are many drivers for Location Based Service (LBS). From the service provider perspective, customized information delivery depending on the end user location is a key driver for offering differentiated service to the end user. Applications can range from location-based advertising, proximity based search service, social networking, emergency response, to enterprise applications such as asset management and fleet tracking, and demographics.

From the operator point of view, network optimization, traffic management and monitoring are some of the examples where User Equipment (UE) positioning information can play a key role in network operation.

UE based technologies typically require a terminal equipped with a Global Positioning System (GPS) receiver and complemented by terrestrial methods such as Observed Time Difference of Arrival (OTDOA). These approaches have been successful in North America for consumer applications. The GPS solution provides positioning accuracy that is unmatched with any other solutions commercially available.

However, UE based positioning technologies have some drawbacks:

GPS based solution does not work for terminals without a GPS receiver or when the GPS signal is not available such as indoors.

UE measurement reporting for OTDOA depends on UE implementation and the accuracy may not be universal available.

OTDOA requires changes in terminal to support measurements for OTDOA, which is not feasible for all terminals, such as Release-8 terminals. Positioning estimation for Release-8 terminals is still needed to enable LBS.

Network based positioning technologies offer an attractive alternative to the UE based positioning methods. Up Link TDOA (UL-TDOA) in the overlay Location Management Unit (LMU) has been successful in the commercial network in GSM and UMTS system. Integrated solution embedded in the eNodeB (eNB) can be a cost-effective solution to the overlay system, while providing the performance of the UL-TDOA.

### SUMMARY OF THE INFORMATION

The following presents a simplified summary of the disclosed subject matter in order to provide an understanding of some aspects of the disclosed subject matter. This summary is not an exhaustive overview of the disclosed subject matter and is not intended to identify key or critical elements of the disclosed subject matter not to delineate the scope of the disclosed subject matter. Its sole purpose is to present some concepts in a simplified form as a prelude to the more detailed description that is discussed later.

Existing network based positioning technology belongs to the following categories:

Basic Cell-ID

Enhanced Cell-ID
Cell-ID+TA (GSM/GPRS/EDGE) and Cell-ID+RTT (UMTS)
Cell-ID+AOA

UL-TDOA

It is feasible to realize basic or enhanced Cell-ID methods for Release 8 UEs. However, the accuracy of these positioning algorithms is fairly limited and further improvement in the network-based positioning method is needed.

UL-TDOA relies on multi-lateration of the measurement of the UL signal transmitted by the UE. The arrival times of the UL signal is estimated at multiple sites. The sites can be cell towers, Remote Radio Heads (RRH), or distributed antenna subsystem (DAS). The UL-TDOA method is particularly suited for indoors or dense urban environments. UL-TDOA is particularly attractive in networks that require minimal changes in the handset: there is no requirement on GPS receiver at the handset nor special receiver is required for DL-TDOA. Systems based on UL-TDOA are available in GSM and UMTS networks in North America.

Network Synchronization Requirements

UL-TDOA should work for both synchronized and asynchronous network deployments. In case of synchronized network, coordination among the subframes of the same SFN number for multi-lateration is possible. Even in the asynchronous network, it is feasible to configure fully or partially overlapping subframes with required UL signals by joint scheduling. DL transmission timing difference of the neighboring cells relative to the serving cell needs to be available at the serving cell for joint scheduling.

UL Signals for UL-TDOA

To support UL-TDOA, UL signals transmitted by the UE need to be detected from multiple sites. Existing UL signals may be used for network based positioning. The UL signals that are supported for Release 8 UEs are PRACH, UL DM RS and SRS.

The UL signals are characterized by the following:

PRACH:

PRACH is periodically configured per cell to allow initial access and handover. There are up to 64 sequences per RPACH resource per cell, which are generated by combination of cyclic-shifted CAZAC sequence and different root CAZAC sequences.

PRACH is detected at the base station and round-trip delay of the UE relative to the cell site is estimated. Timing Advance (TA) is derived at the eNB and sent to the UE.

PRACH can be useful for idle mode positioning and during DRX period.

Typically, PRACH subframe is configured with offset in time among neighboring cells for the purpose of distributing eNB processing load. However, UL-TDOA, the same PRACH signal transmitted from the UE has to be detected by multiple sites. Without coordination among PRACH resource configuration among multiple sites, signal may not be detectable by base stations in neighboring sites.

PRACH bandwidth is limited to 6 PRBs. The timing accuracy provided by the narrow bandwidth signal is limited.

SRS and DM RS: For in-cell multiplexing, hybrid of CDM/FDM for SRS, FDM for DM RS for non-MIMO and hybrid FDM/CDM for MU-MIMO. Intra site orthogonality is achieved by cyclic-shifted CAZAC root sequences. For inter-cell multiplexing, CDM by CAZAC root sequences which are associated with PCID. Interference randomization is achieved among UEs served by neighboring cells:

Both signals are transmitted by UEs synchronized to the serving cell. These signals are not available from unsynchronized UEs.

Users are multiplexed by CDM and are independently configured. The sequence is determined by the PCID. It is not feasible for the neighboring cells to know the SRS pattern of the UE from neighboring sites.

Both signals suffer from near-far problem. These signals are power controlled by the serving cell. When the serving cell is lightly loaded and the neighbour cell is heavily loaded. The transmission power of the UE may be too low to be detected in neighboring cells.

DMRS is available during active transmission (ie, when there is PUSCH transmission scheduled.) This signal is not available when there is no UL traffic, eg when UE buffer is empty.

Based on the above observation, UL signals from Release 8 has significant limitations for UL-TDOA. A new UL positioning reference signal (UL-PRS) is needed for UL-TDOA.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein

FIG. 1 is a graph depicting position estimation accuracy depending on PRS bandwidth;

FIG. 2 is a schematic diagram that illustrates the principles of UL-TOA reception for tri-lateration;

FIG. 3 illustrates a Latin Square of order N=7;

Error! Reference source not found. shows the co-channel interference mitigation characteristic of the Zadoff-Chu sequence for sequence lengths ranging from 3 to 151; and

Error! Reference source not found. illustrates mapping of PRS sequence to the resource elements;

FIG. 6 is a schematic diagram of a system architecture for LBS system according to the principles of the invention;

FIG. 7 is a schematic diagram of a system architecture for LBS system according to the principles of the invention;

FIG. 8 is a schematic diagram of a system architecture for an indoor application of a LBS system according to the principles of the invention with pilot beacons added to passive DAS and including a Base Station Interface;

FIG. 9 is a schematic diagram of an indoor application of a LBS system according to the principles of the invention with pilot beacons added to passive DAS and including a Common Public Radio Interface (CPRI);

FIG. 10 is an illustration of an example Down Link Reference Signal (DL RS) in LTE; and

FIG. 11 is an illustration of PRS in LTE Subframe Structure.

### DETAILED DESCRIPTION

Various example embodiments will now be described more fully with reference to the accompanying figures, it being noted that specific structural and functional details disclosed herein are merely representative for purposes of describing example embodiments. Example embodiments may be embodied in many alternate forms and should not be construed as limited to only the embodiments set forth herein.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. As used herein the description, the term “and” is used in both the conjunctive and disjunctive sense and includes any and all combinations of one or more of the associated listed items. It will be further understood that the terms “comprises”, “comprising,”, “includes” and “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

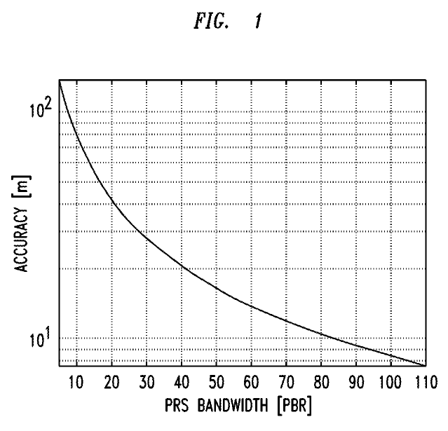

FIG. 1 is a graph depicting position estimation accuracy depending on PRS bandwidth. Timing resolution depends on the bandwidth of the signal. For a signal with bandwidth of B Hz, the timing of the signal can be determined with the accuracy of ±½B. What this means is that if there are two users that are apart by ±½B, the two signals can be detected without ambiguity. The timing estimation accuracy is translated to positioning accuracy. The positioning accuracy depending on the available PRS bandwidth is shown in Error! Reference source not found. Based on this analysis,

Table 1 summarizes the required PRS bandwidth for the desired position estimation accuracy. To obtain spatial accuracy of 50 m or better, the minimum PRS bandwidth of 17 PRBs is required. To achieve the estimation accuracy of 20 m and 10 m, the PRS bandwidth needs to be 42 and 83 PRBs. The required bandwidth approaches the system bandwidths for 10 MHz and 20 MHz system. From this analysis, a wide bandwidth PRS which spans the entire system bandwidth is desirable for high-resolution positioning.

TABLE 1
Desired position estimation accuracy and required PRS bandwidth.

| Estimation accuracy | PRS bandwidth |
|---|---|
| [m] | [PRB] |
| 10 | 83 |
| 20 | 42 |
| 30 | 28 |
| 40 | 21 |
| 50 | 17 |
| 100 | 9 |

UL-TDOA Design For LTE

In UL-TDOA for LTE, serving cell computes the UE positions with the support of coordinated scheduling aided by information exchange through the X2 interface.

The Proposed Solution Comprises

Coordinated silencing by joint scheduling of UL subframes.
The solution works for both synchronized and non-synchronized network deployments.

Introduction of UL positioning reference signal (UL-PRS) that is transmitted in normal subframes
Improved hearability by increasing the reuse distance.
Minimize PRS collision among neighboring cell UEs by FDM with frequency hopping.

UL-TDOA for LTE

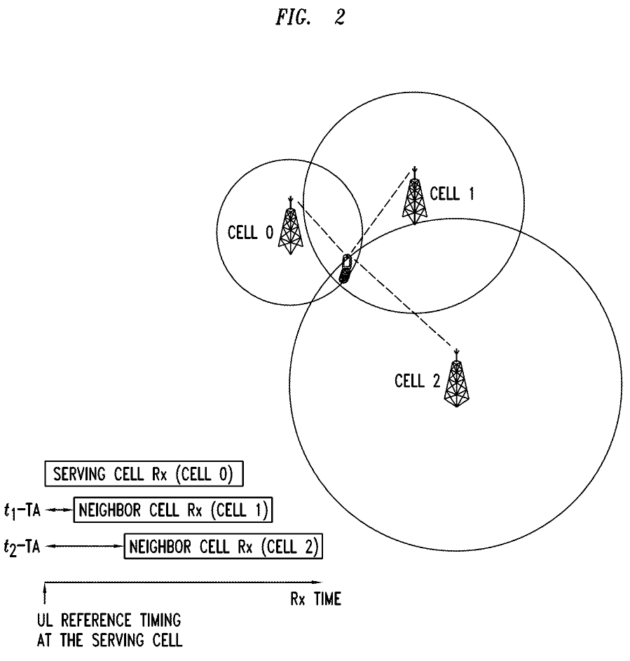

FIG. 2 is a schematic diagram that illustrates the principles of UL-TOA reception for tri-lateration. The UE transmits a known reference signal called Uplink Positioning Reference Signal (UL-PRS) in a known subframe. The arrival time of the UE is estimated at multiple cell sites. The transmission timing is controlled by the Timing Advance (TA) command of the serving cell so that the received signals are synchronized. Let t₁ and t₂ denote the one-way delay of the signal from the UE to neighboring sites (cell 1 and cell 2). The estimated delays t₁ and t₂ between the UE and the neighboring cells are reported to the serving cell.

The one-way delay between the UE and the serving cell is computed from Timing Advance command:

During initial access or handoff, the Timing Advance can be computed from Random Access channel detection. The one-way delay between the UE and the serving cell is T₀=TA₀.

During active mode, Timing Advance is computed from uplink traffic channel or SRS. The one-way delay between the UE and the serving cell is computed by accumulating Timing Advance commands, ie

$${T}_{0} = {\sum }_{n = 1}^{ } {TA}_{n}$$

The serving cell then computes the one-way delay between the UE and cells 1 and 2 as t₁+T₀, and t₂+T₀, respectively. UE position can be computed by tri-lateration.

UL-TDOA

In UL-TDOA, trilateration can be done by TDOA instead of absolute delay between the UE and neighboring cells. The UE is UL synchronized relative to the serving cell reference timing. In this case, UE position can be calculated from measurements t₁ and t₂.

Enhanced Resolution UL-TDOA

The resolution of TA command is limited to 16 Ts, which is 521.6 nsec. However, fine timing estimation at sample or sub-sample rate is feasible depending on eNB implementation. Enhanced resolution UL-TDOA is possible. Tri-lateration is done from estimated arrival times of the signal t₀, t₁ and t₂.

The tri-lateration method may be extended to multi-lateration for improved accuracy.

### Joint Scheduling

In LTE, universal frequency reuse is employed in neighboring cells. Fractional frequency reuse (FFR) or soft fractional frequency reuse (SFFR) can be configured for traffic channel, depending on traffic loading and neighbour cell interference. However, no such mechanism exists for PRACH or SRS.

In LTE Release 8, the signals transmitted from the UE are measured by the serving cell. Signals from UEs served by neighboring cells are considered as interference. For UL-TDOA, the UL signal needs to be estimated, or ‘heard’ from the neighboring cells as well as serving cells. This requires improvement in SINR compared with Release 8 design.

The invention methodology uses special UL-PRS transmission with joint scheduling. Traffic channel in neighboring cells are muted by coordinated scheduling. This scheme allows UEs to measure PRS signals from multiple sites without traffic channel interference. Normal subframe can be reused with joint scheduling among neighboring cells. If MBSFN subframe is used, these frames could be periodically configured for UL-PRS transmission.

Asynchronous Network Deployment

In case of synchronized eNBs, UL-PRS subframe from neighboring sites experiences interference from neighboring cell traffic channel. To improve hearability, interference to neighbor cells is reduced by muting traffic channel when neighboring cell UL-PRS subframe is active. This may be achieved by joint scheduling. The serving cell scheduler communicates with neighbour cell scheduler to coordinate the allocation of UL-PRS transmission in time (ie subframe) and frequency (PRBs) by communication through the X2 interface. This joint scheduling approach would allow the serving cell to minimize the interference to neighboring cells.

Synchronized Network Deployment

For synchronized network deployment, joint scheduler ensures that UL-PRS subframes overlap or partially overlap in time. In the sub-frames where UL-PRS is configured, UL-PRS is measured by multiple cells in neighboring sites. UE is configured to transmit UL-PRS in the UL-PRS subframe. Neighboring cells that do not have UL-PRS transmission is muted to minimize the traffic channel interference. Normal subframe can be used for UL-PRS transmission.

UL-PRS Frequency Pattern

To allow positioning, multiple UEs in a cluster of sites need to send the PRS simultaneously. CDM suffers from near-far problem when the UL-PRS signals from two UEs served by different cells arrive at the same cell for UTDOA measurement. The invention methodology entails hybrid of FDM/TDM for UL-PRS.

Issues that may be addressed by one or more embodiments of the invention include:

Reuse 1 is assumed on UL for UEs in neighboring cells. Co-channel interference among neighboring cell UEs when the signal is transmitted;

Power control from serving cell. Near-far effect; and

Imperfect time synchronization.

FDM advantage over CDM include one or more of:

Robust to imperfect time synchronization among neighboring sites;

If large number of frequency hopping patterns with minimal collision can be found, co-channel interference can be reduced significantly;

Easy implementation of receiver;

Can use sequences with desirable properties (PN sequence) on top of FDM signal;

To further randomize co-channel interference;

Possibility for efficient receiver structure depending on sequence choice; and

FDM with regular tone spacing: Still preserves SC property (ex. SRS)

Concept of Latin Squares

Frequency Hopping based on orthogonal Latin Squares are proposed in the literature to improve time/frequency reuse in cellular communication systems.

For a prime number N, Latin Square of order N is an N×N matrix with entries from a set R={0, 1, . . . , N−1} of distinct elements. The Latin Square A is constructed as

{A}_{k,l}=(ak+l)(mod N),k,l=0, . . . , N−1 Eq. 1

where α=0, 1, . . . , N−1 and (k,l) is the frequency/time index. There are N−1 orthogonal Latin Squares. Frequency hopping pattern generated from orthogonal Latin Square has a unique property that there is only one time/frequency collision for every pair of ordered pairs. Error! Reference source not found. shows an example of Latin Square of order N=7.

The element (k,l) of Latin Square represents unique RS pattern from neighboring sites. The index (k,l) represents distinct resource element (RE) occupied by neighboring base stations, where k and l represent the subcarrier and OFDM symbol index. The advantages of PRS construction by Latin Square include:

Flexibility in supporting different reuse patterns.
In the example with N=7, frequency reuse of 6 is possible. Beyond that, time-frequency of PRS signal is assigned from frequency hopping patterns from different Latin Square, allowing to randomized interference and minimize collision. These additional patterns could be used for UEs served by neighboring cells.

PRS (Frequency hopping) pattern is generated by simple arithmetic operation.

Generation PRS Pattern

The PRS sequence can occupy large bandwidth. In this case, the Latin Square pattern is replicated in the frequency domain to generate a longer PRS sequence. A PRS sequence of length M is generated by following the steps below.

Step 1: A desired reuse distance of (N−1) is chosen where N is a prime number.

Step 2: A Latin Square of order N is generated as in equation Eq. 1.

Step 3: A PRS pattern of length M is generated by replicating each column of the Latin Square by

$$R = ⌊ \frac{M}{N} ⌋$$

times.

Step 4: There are N distinct PRS patterns. These patterns are allocated to users served by the same cell. Alternatively, these PRS patterns can be allocated to users belonging to the same site, if the cells in the same site are synchronized.

Step 5: There are (N−1) distinct Latin Squares which can be allocated to neighboring cells or sites.

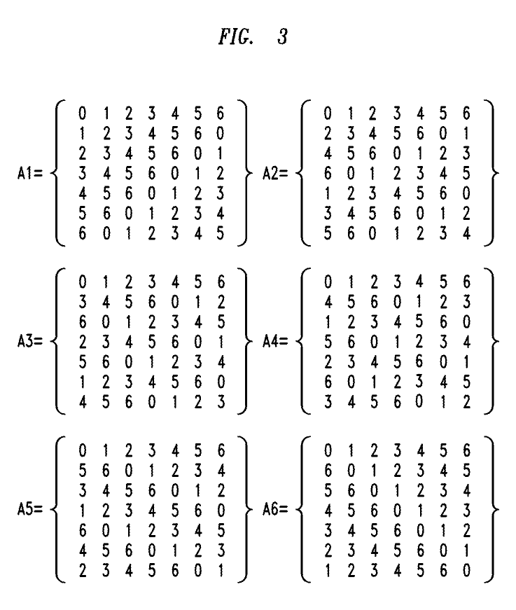

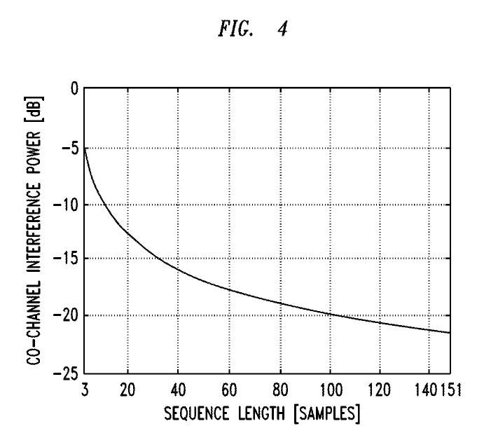

As an example, consider the PRS bandwidth of 5 MHz, which contains 512 subcarriers. A PRS sequence with reuse distance of 6 can be generated by replicating 73 times each column of a Latin Square of order 7, resulting in a PRS sequence of length 511. FIG. 3 illustrates a Latin Square of order N=7.

TABLE 2
PRS length depending on system bandwidth and reuse distance

| | PRS length | |
|---|---|---|
| | Reuse 6 (Latin Square | Reuse 30 (Latin Square |
| System Bandwidth | of order 7) | of order 31) |
| 5 MHz | 511 (=73 × 7) | 496 (=16 × 31) |
| 10 MHz | 1022 (=146 × 7) | 992 (=32 × 31) |
| 20 MHz | 2044 (=292 × 7) | 1984 (=64 × 31) |

PRS Sequence Generation

PRS sequence with good correlation property provides interference immunity by interference randomization or suppression. The PRS sequence of length R×N is used to provide the desired interference characteristic. Candidates of PRS sequences are binary sequences (e.g. Gold sequence, m-sequence, or Kasami sequence) or CAZAC polyphase sequences such as Zadoff-Chu sequence. The GCL sequences are characterized by:

1. Unit magnitude in the transform domain

2. Optimal cyclic auto-correlation

3. Low, constant cyclic cross-correlation for odd-length sequence

Zadoff-Chu sequence falls in the category of GCL sequences and is used extensively in LTE uplink. The Zadoff-Chu sequence cₚ (n) of length P is generated as

$${c}_{p} ( n ) = \{ \begin{matrix}exp [ \frac{j2π p}{P} ( n + \frac{n ( n + 1 )}{2} ) ] for P odd \\ exp [ \frac{j2π p}{P} ( n + \frac{{n}^{2}}{2} ) ] for P even\end{matrix} \qquad Eq . ( 1 )$$

Due to the optimal cyclic auto-correlation property, co-channel interference from UEs allocated sharing the same time-frequency resource can be suppressed. Error! Reference source not found. shows the co-channel interference mitigation characteristic of the Zadoff-Chu sequence for sequence lengths ranging from 3 to 151. For sequence lengths 73, 146, and 292, co-channel interference can be suppressed by 18.6 dB, 21.6 dB, and 24.7 dB.

For intra cell UEs, the same CAZAC root sequence is used.

For neighboring cells with different PRS frequency pattern, the same CAZAC root sequence can be used.

For neighboring cells that have the same PRS frequency pattern, different CAZAC root sequence shall be used to randomize the interference.

PRS Sequence Mapping

Error! Reference source not found. illustrates mapping of PRS sequence to the resource elements. Each UE is associated with a PRS pattern in the frequency domain and a PRS sequence. The PRS sequence is mapped to the Resource Elements (REs) for each slot, in increasing frequency order. For a 10 MHz system, with frequency reuse of 7,
PRS pattern with 1022 REs is assigned to a UE, denoted as UE0;
A Zadoff-Chu sequence of length 1022 is generated and assigned to UE0. The sequence is denoted as Z₀ (i), where i=0, . . . , 1021;
A slot is assigned for PRS transmission;
Sequence is allocated to a PRS block of size 7×7. Denoting the (k,l)^{th} element of the 7×7 block as RE(k,l), where k,l=0, . . . 6,

a. The 0^{th} element of the sequence is allocated to RE(0,0) of a slot.

b. The 1^{st} element of the sequence is allocated to RE(1,6) of a slot.

c. The 6^{th} element of the sequence is allocated to RE(6,1) of a slot.
The PRS sequence mapping is repeated for the next frequency block, while PRS sequence index is incremented by 1.

By following the above steps, the PRS sequence is allocated to the entire bandwidth for a slot.

PRS Repetition

The duration of PRS sequence is configured to be a slot or a subframe. To provide sufficient energy to achieve the required PRS SINR, the PRS pattern is repeated in time:

The sequence is repeated periodically in time by a higher layer configuration.

The repetition can be configured by RRC signalling on a per-UE or per-cell basis.

Collision Avoidance

To avoid persistent collision with the PRS sequence of the same interfering UE in the neighbour cells, two approaches are employed:

PRS pattern hopping which may employ one or more of the following:
Initial PRS frequency hopping pattern is generated for each cell. The hopping pattern is associated with the PCID (Physical Cell ID).
The frequency hopping pattern changes over time. The frequency hopping pattern changes either at the slot rate or the sub-frame rate.
The PRS pattern hopping can be turned on/off by higher layer configuration.

PRS sequence shift/hopping which may employ one or more of the following:
Each UE is assigned an initial value of a sequence shift/hopping pattern. The sequence shift/hopping pattern is associated with the PCID.
The PRS sequence changes over time. The change can be either at the slot rate or subframe rate.
The PRS sequence shift/hopping can be turned on/off by higher layer configuration.

These schemes provide interference immunity by randomizing the interference.

Fractional Loading

Loading of PRS sequence depends on two factors:

reuse distance

number of users simultaneously transmitting the PRS in the same time-frequency resource

With the proposed PRS pattern, loading can be controlled flexibly, either by network planning or by self-optimization.

PRS Planning

In case of planned network deployment, one can configure PRS reuse distance and the corresponding sequence depending on expected cell loading by planning. The configuration can be done statically or semi-statically by an eNB OAM configuration. The number of users simultaneously transmitting the PRS is also semi-statically configured by the eNB.

SON Feature

Self-optimizing network should be able to adjust PRS configuration without planning. To enable this feature, a few additional design considerations are made:
Hopping pattern and sequences are ties with Cell ID, removing the requirements for planning PRS.
Adjust the number of users with simultaneous PRS transmission in a given time-frequency resource depending on loading:
In planned system, eNB defines the number of users with simultaneous PRS transmission, and configures these users individually with specific transmit opportunity.

In a SON, the number of users is controlled based on eNB measurement of PRS loading. The PRS loading is measured by the interference-plus-thermal measurement in a time-frequency resource where the PRS is configured.

Option 1: RRC reconfiguration is employed to adjust the PRS loading. The number of users with simultaneous PRS transmission can be reduced or increased.

Option 2: One can change the probability of PRS transmission for each user. RRC configuration such as transmission probabilities is used to change the loading. When the loading is high, the transmission probability can be increased. When the loading is low, the probability can be decreased.

Extension to DAS System

The invention methodology may be advantageously extended to indoor applications involving distributed antenna systems (DAS) where each antenna does not have a unique ID. In this manner is provided a solution for E911/LDS in LTE networks that are deployed with indoor/outdoor distributed antenna system (DAS, particularly the indoor E911/LDS where existing methods such as Assisted Global Positioning System (AGPS) and Down Link Observed Time Difference of Arrival (DL-OTDOA) do not work well.

3GPP currently is specifying support for three location enabling technologies: AGPS, DL-OTDOA and Enhanced Cell ID (ECID). For a UE initiated a call in indoor, none of the three methods provide satisfactory accuracy. AGPS provides great accuracy when the UE can see open skies but GPS signals are attenuated significantly indoors thus rendering poor detectability indoors hence poor accuracy. AGPS may work ok in “light” indoor conditions (beside windows, top floor, etc.), but is not functioning in deep indoor

DL-OTDOA faces similar challenges. DL-OTDOA relies on UE to detect Reference Signals (RS) transmitted by eNBs, but those RF signals are typically blocked inside even with the help of eNB transmitting Position RS (PRS). The shortcomings of DL-OTDOA are further exacerbated when the signal form the cell tower is simultaneously broadcast to multiple locations. This simulcast technique is popular for coverage hole filling in campus environment in which the signal from one cell or sector is simulcast to multiple locations. When a cell is simulcast it cannot be used for tri lateration or multi-lateration because the location of the cell tower is no longer unique.

In a further embodiment of the invention, a solution for E911/LBS in a LTE wireless network deployed indoor DAS is provided. The solution can be extended to outdoor DAS, repeater and leaky cable for tunnels. The location accuracy can be further improved with RF fingerprinting. Similar idea of PRS marking can be extended to indoor CDMA network.

An entity associated with each radio head that configures Position Reference Signal (PRS) which will give each of the simulcast radio head a unique identity. The PRS is specifically defined for position determination purpose. It is a specific pseudo random sequence. OFDM symbol#, slot#, and/or the subframe# are defined as a function of PHY layer cell identity. The association is defined statically or semi-statically, either by OAM or RRC configuration. The PRS pattern may be defined for normal or Multicast Broadcast Single Frequency Network (MBSFN) subframes that uses normal or extended CP, respectively.

The UE served by a unique simulcast point, which contains a remote radio head (RRH), an antenna and an entity to configure the PRS, will report the PRS it has decoded and can thus be located by the coordinates of the antenna, either obtained manually by survey or by automatic positioning with GPS and some special algorithm. Because each simulcast antenna covers a small area with a radius about 50 m, the UE location accuracy should meet the FCC mandate for E911 or requirements form commercial location based service (LBS).

The coordinates of the simulcasting antennas connected to the same eNB will be entered as part of the Base Station Almanac (BSA) for that eNB and transmitted to the location server where the calculation of the UE is performed.

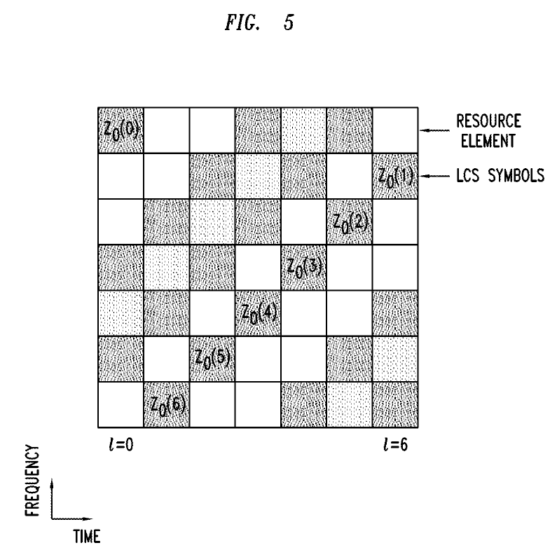

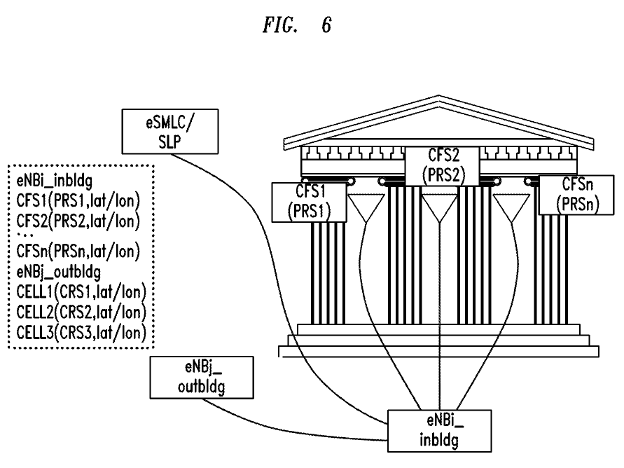

FIG. 6 is a schematic diagram of a system architecture for LBS system according to the principles of the invention. Position Reference Signal equipment (PRS) (here denoted as LBS ClearFill Star equipment (LBS CFS)) is an inexpensive box to ‘mark’ the PRS to assign a unique ID to each CFS point which is associated with an antenna of DAS. The coordinates (lat/lon) of each CFS will be surveyed and put into eNB Almanac database in eSMLC/SLP. The UE will return its measurement of PRS to allow UE assisted location (3GPP RAN1/RAN2 impact). For improved accuracy, the eNBs may be distinguished with inbldg_DAS and outbldg_normal, outbldg_DAS, outbldg_rptr. The UE location will be determined by 1st by cell ID (CFS ID), and then refined with integration of RF Fingerprinting (proprietary method with Polaris), based on the vector containing UE measurement of multiple CFS(PRS) signals

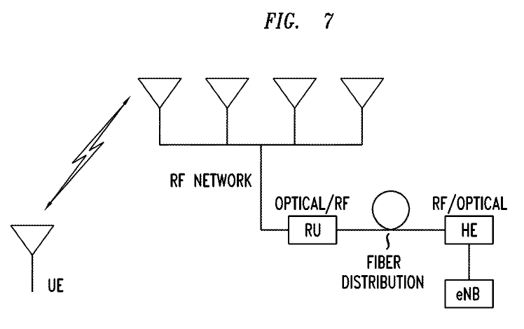

FIG. 7 is a schematic diagram of a system architecture for LBS system according to the principles of the invention. UE transmits PRS information to DAS. DAS is connected via RF network to Remote Unit (RU) which provides optical to RF on Downlink and RF to Optical on the uplink RU. Via fiber distribution, RU is connected to Head End (HE) which provides RF to Optical on the Downlink and Optical to RF on the uplink for connection to the eNB. LBS is provided by the eNB.

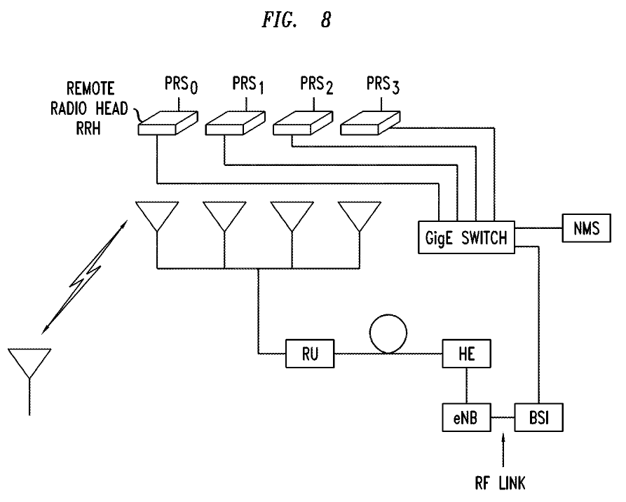

FIG. 8 is a schematic diagram of a system architecture for an indoor application of a LBS system according to the principles of the invention with pilot beacons added to passive DAS and including a Base Station Interface. Position Reference Signal equipment (PRS) is associated with antenna of DAS. These Remote Radio Heads (RRH) are connect to router by for example, CAT 5 cable. The RRH may be powered by Power Over Ethernet POE. NMS configures PRS and monitors health of Remote Radio Heads. Base Station Interface (BSI) gets timing from the eNB. This option will be required if the eNB vendor does not have Common Public Radio Interface (CPRI).

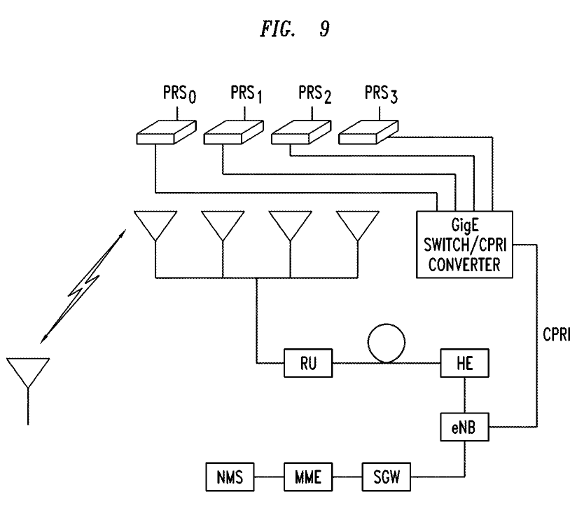

FIG. 9 is a schematic diagram of an indoor application of a LBS system according to the principles of the invention with pilot beacons added to passive DAS and including a CPRI.

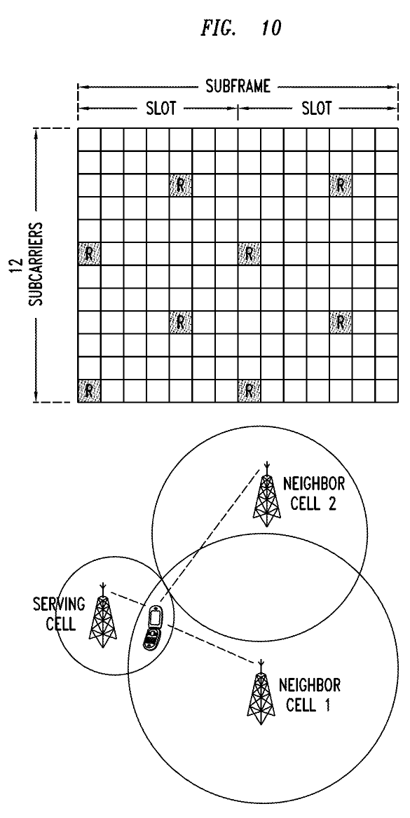

FIG. 10 is an illustration of an example Down Link Reference Signal (DL RS) in LTE. Reference signals (RS) are used to facilitate carrier offset estimate, channel estimation, timing synchronization, etc. There are 504 RS that can be labeled for each cell/sector without ambiguity. The RS have a specific pseudo random sequence. OFDM symbol#, slot#, and/or the subframe# are defined as a function of PHY layer cell identity.

However, UE does not measure the relative time difference between the arrival of RS from neighboring eNodeBs wrt to that of the serving eNodeB. To support DL OTDOA, 3GPP RANI specified the measurement of OTDOA of RS at UE for E911/LBS. Additionally, LTE does hard HO and UE measures RS from neighbor cells' RS only during HO. 3GPP RANI specified UE measuring RSs for E911/LBS. Due to interference and frequency reuse, UE hearability is poor at UE. 3GPP RANI/2 specified Position RS to help.

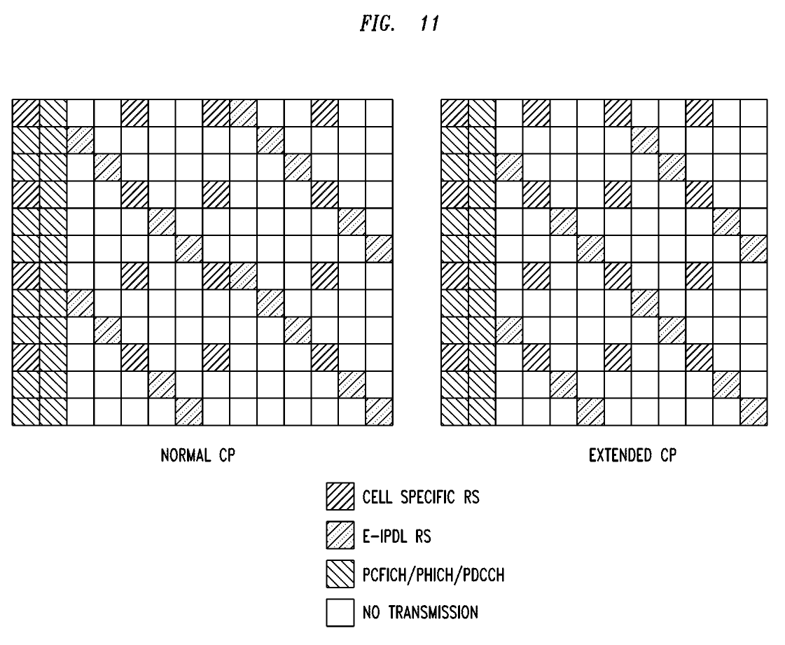

FIG. 11 is an illustration of PRS in LTE Subframe Structure. Positioning reference signals configuration Index: Configures the periodicity and offset of the subframes with positioning reference signals. RANI suggests periodicities of 160, 320, 640 or 1280 subframes. Number of consecutive downlink subframes: Configures number of consecutive downlink subframes with positioning reference signals. RANI suggests 1, 2, 4 or 6 consecutive subframes. The association is defined statically or semi-statically, either by OAM or RRC configuration. The PRS pattern may be defined for normal or MBSFN subframes that uses normal or extended CP, respectively

A variety of the functions described above with respect to the exemplary method are readily carried out by special or general purpose digital information processing devices acting under appropriate instructions embodied, e.g., in software, firmware, or hardware programming. For example, functional modules of the FLOCS can be implemented as an ASIC (Application Specific Integrated Circuit) constructed with semiconductor technology and may also be implemented with FPGA (Field Programmable Gate Arrays), photonic integrated circuits (PIC) or any other suitable hardware blocks. In the case of software instructions, the software is stored in a memory and the stored instructions are carried out by a processor configured to executed the stored instructions.

What is claimed is:

1. A method comprising:
computing a location of a user equipment (UE) wherein said computing includes
joint scheduling of UL subframes; and
receiving a Up Link Positioning Reference Signal (UL-PRS).

2. The method of claim 1 wherein said computing is performed by a network equipment that serves a cell.

3. The method of claim 1 wherein the UL-PRS is received in a known subframe.

4. The method of claim 1 wherein said computing comprises:
estimating an arrival time for a plurality of cell sites.

5. The method of claim 4 wherein said computing further comprises:
determining a one-way delay between the UE and the plurality of cell sites; and
determining the location via tri-lateration.

6. An apparatus comprising:
a memory for storing a plurality of instructions;
a processor for executing said instructions, said instructions when executed computing a location of a user equipment (UE) wherein said computing includes
joint scheduling of UL subframes; and
receiving a Up Link Positioning Reference Signal (UL-PRS).
